(19) United States
(12) Patent Application Publication
(10) Pub. No.: US 2012/0147199 A1
(43) Pub. Date: Jun. 14, 2012

(54) WIRELESS SERVICE WITH PHOTO PRINT FEATURE

(75) Inventor: Robert H. Lorsch, Los Angeles, CA (US)

(73) Assignee: THE RHL GROUP, INC., Beverly Hills, CA (US)

(21) Appl. No.: 13/325,405

(22) Filed: Dec. 14, 2011

Related U.S. Application Data
(60) Provisional application No. 61/423,070, filed on Dec. 14, 2010.

(51) Int. Cl. H04N 5/225

(52) U.S. Cl. 348/207.2; 348/E05.024

(57) ABSTRACT

A method includes receiving a digital photograph from a wireless device associated with a subscriber to a wireless service, printing at least one print of the digital photograph, transferring the at least one print of the digital photograph to the subscriber of the wireless service, and billing the subscriber of the wireless service for the at least one print of the digital photograph on a bill which also bills the subscriber of the wireless service for use of the wireless service.

### CROSS-REFERENCE TO RELATED APPLICATIONS

This application claims priority under 35 U.S.C. §119 of a provisional application Ser. No. 61/423,070 filed Dec. 14, 2010, and is hereby incorporated by reference in its entirety.

### FIELD OF THE INVENTION

The present invention relates to wireless telecommunications services. More particularly, but not exclusively, the present invention relates to apparatus, methods, and systems to tie photofinishing services to wireless services.

### BACKGROUND OF THE INVENTION

Cell phones and cell phones with cameras are ubiquitous. Users of camera-equipped cell phones often take photos which they may then transfer to computers or other devices, transmit over a telecommunications network via email, or transmit over the telecommunications network in the form of messages. Thus, substantial bandwidth of wireless telecommunications services is used for communicating photos over the communications network.

A seemingly unrelated problem, absent this disclosure, is that users sometimes want actual printed photos and not merely the digital photos. This typically requires a user to upload photos to a photo finisher web site or visit a photo finishing location, transferring the digital photos to a computer and then printing, or otherwise requiring a user to perform activities which are inconvenient to the user. Due to these inconveniences many times a user may not go through the steps necessary to obtain printed photos even in instances where they desire printed photos.

What is needed is a more convenient method for cell phone users to obtain photo prints in a way which is facilitated by a wireless service provider.

### SUMMARY OF THE INVENTION

Therefore, it is a primary object, feature, or advantage of the present invention to improve over the state of the art.

It is a further object, feature, or advantage of the present invention to provide a solution that allows wireless service providers to provide additional services to their subscribers.

Another object, feature, or advantage of the present invention is to provide a simple and convenient method for cell phone users to receive professionally photo-finished versions of their digital photos.

Yet another object, feature, or advantage of the present invention is to provide a simple and convenient payment system for financial transactions associated with photo-prints.

A further object, feature, or advantage of the present invention is to provide a cell phone which acts as a platform for photofinishing services without requiring users to acquire separate applications for their phone.

A still further object, feature, or advantage of the present invention is to provide a cell phone which seamlessly integrates functionality associated with photo-finishing services.

Yet another object, feature, or advantage of the present invention is to provide a cell phone with a user interface which provides functionality associated with photo-finishing services.

A still further object, feature, or advantage of the present invention is to provide a cell phone which integrates functionality associated with photo-finishing services into the hardware of the phone.

One or more of these and/or other objects, features, or advantages of the present invention will be apparent from the specification and claims that follow. No single embodiment need achieve all or any of these objects and the present invention is not to be limited by or to these objects, features or advantages.

According to one aspect of the present invention a method includes providing a wireless device to a user wherein the wireless device includes (a) a housing, (b) a camera, (c) a wireless transceiver disposed within the housing, (d) an intelligent control, and (e) a photo print component wherein the photo print component assists in receiving an indication from a user that a digital photo acquired by the camera is to be printed and communicating the digital photo using the wireless transceiver over a cellular network. The method further includes storing within a database a transaction record associated with photo printing of the digital photo and electronically generating a bill containing the transaction record associated with photo printing of the digital photo and at least one transaction record associated with providing a telecommunications service over the wireless device. The photo print component may include elements integrated into the operating environment of the wireless device. The photo print component may be at least partially implemented in hardware or at least partially implemented within an integrated circuit. The photo print component may assists in displaying on a display of the wireless device an icon associated with photo print services. The method may further provide for printing the bill. Alternatively the bill may be an electronic bill. The transaction record associated with photo printing of the digital photo may be for the purchase and delivery of at least one photo print or for the purchase and pickup of at least one photo print or a periodic charge for a set number of photo prints or a periodic charge for an unlimited number of photo prints. The method further provides for printing the digital photo. The method may further provide for setting parameters for printing the digital photo based on the wireless device used to acquire the digital photo. The wireless device may be a cellular phone.

According to another aspect a method is provided which includes receiving a digital photograph from a wireless device associated with a subscriber to a wireless service over a telecommunication network, printing at least one print of the digital photograph, transferring the at least one print of the digital photograph to the subscriber of the wireless service, and billing the subscriber of the wireless service for the at least one print of the digital photograph on a bill which also bills the subscriber of the wireless service for use of the wireless service. The transferring step may include mailing the at least one print of the digital photograph to the subscriber of the wireless service. The billing step may include billing for the at least one print of the digital photograph on a per print basis. The method may further include queuing a set of digital photographs including the digital photograph and printing and transferring the digital photograph as a part of the set of digital photographs.

According to another aspect a method for providing wireless services is provided. The method may include collecting a first transaction record from a database for a wireless service, collecting a second transaction record for a photo printing service, and electronically generating a bill containing the first transaction record and the second transaction record using a computerized billing system. The method may further include providing a wireless device to a user wherein the wireless device includes (a) a housing, (b) a camera, (c) a wireless transceiver disposed within the housing, (d) an intelligent control, and (e) a photo print component wherein the photo print component assists in receiving an indication from a user that a digital photo is to be printed. The method may further include receiving the indication from the user that a digital photo is to be printed. The method may further include printing the digital photo.

According to another aspect, a cellular phone is provided. The cellular phone includes a housing, a camera, a wireless transceiver disposed within the housing, an intelligent control, and a photo print component integrated into an operating environment of the cellular phone, wherein the photo print component provides for receiving an indication from a user that a digital photo acquired by the cellular phone is to be printed and then communicating the digital photo using the wireless transceiver over a cellular network. The indication from a user may be in the form of a selection of an icon. The step of communicating the digital photo using the wireless transceiver over the cellular network may include communicating the digital photo to a wireless service provider associated with a photofinishing service.

According to another aspect of the present invention a method includes providing wireless service to a wireless device associated with a wireless service subscriber, providing the wireless device to the wireless service subscriber, providing on the wireless device means to select a digital photograph for photo printing to a photo printing service associated with a provider of the wireless service, and electronically generating a bill containing a first transaction record associated with the photo printing service and a second transaction record associated with the wireless service using a computerized billing system. The wireless device may be a cellular phone.

### BRIEF DESCRIPTION OF THE DRAWINGS

FIG. 1 provides an overview of one embodiment of the present invention.

FIG. 2 illustrates a block diagram of one embodiment of a cellular phone configured to provide photo print services.

FIG. 3 is a block diagram of a representative device.

FIG. 4 is a block diagram of a system which may be used for billing.

FIG. 5 is one example of a screen display.

### DETAILED DESCRIPTION

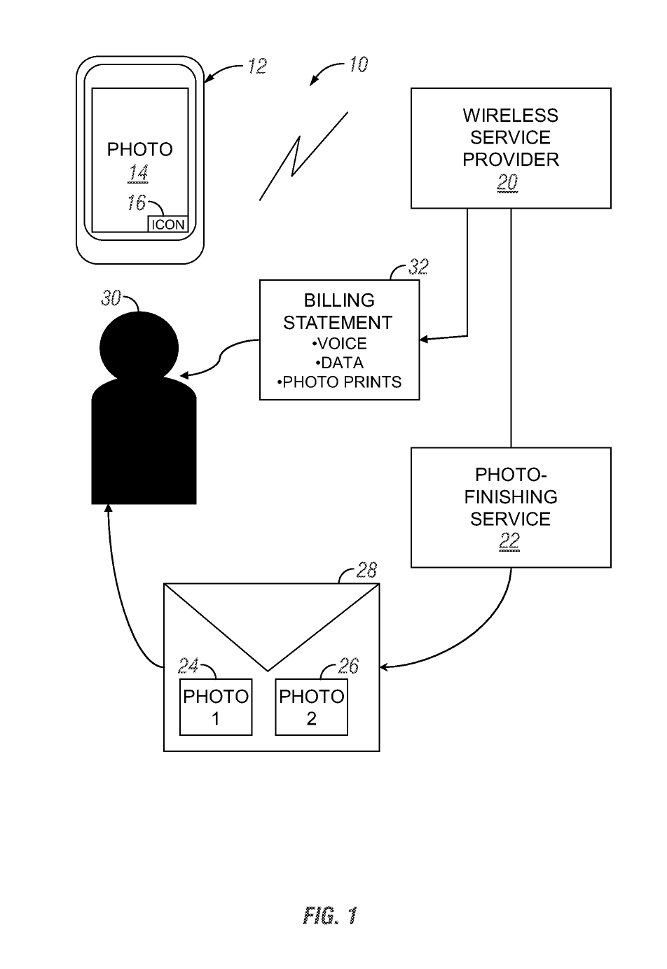

FIG. 1 provides an overview of one embodiment of the present invention. In FIG. 1, a system 10 is shown. The system includes a wireless device 12 which may be a cellular phone or other type of mobile device. The wireless device 12 is equipped with at least one camera so that the wireless device 12 can take photos. Upon taking or viewing a photo a photo print icon 16 is displayed. The photo print icon 16 may displayed on or proximate the photo 14. The photo print icon may, but need not, include a trademark associated with a known photofinisher.

The user may select the photo print icon to indicate that the user wishes to obtain one or more photo prints corresponding with the digital photo 14 displayed on the wireless device 12. Upon such selection or other indication by the user of a desire to receive prints, the digital photo is communicated to the wireless service provider 20 over the wireless network. It is contemplated that due to bandwidth limitations or other concerns that the photo need not necessarily be immediately transferred. For example, if there is no wireless signal present the transfer could be delayed until one was present.

Once in receipt of the photo, the wireless service provider 20 communicates the digital photo 14 to a photofinishing service 22. The photofinishing service 22 may be a part of, related to, or independent of the wireless service provider 20. The photofinishing service then creates one or more photo prints 24, 26 from the digital photo 14. These prints may then be mailed to an address associated with the user 30 of the wireless device 12 (or other address designated by the user). It is to be understood that the present invention contemplates variations in the manner of delivery. For example, the photos could be picked up instead if that is the preference of the user.

The wireless service provider 20 maintains an accounting associated with the number of digital photos which are printed. The wireless service provider 20 may then bill the user 30 in their normal billing statement 32, regardless of whether billing is via paper or electronically. Although it may be preferable for the wireless service to maintain the accounting and providing the billing so as to reduce the number of bills the user receives, the present invention contemplates that a user may pay in a separate transaction instead. It is further contemplated that a separate account may be used, banking information may be separately obtained, or the financial transaction may be otherwise performed. Another type of alternative financial arrangement would be that for a fixed period fee the user 30 receives a set number or possibly an unlimited number of photo prints instead of being charged on a per photo basis.

It is to be further appreciated that the present invention contemplates that to reduce mailing charges, or possibly to reduce a number of financial transactions, photos may be queued until a particular number of photo print requests have been made. Alternatively, the photos may be mailed periodically (e.g. once a week, or not more than once a day).

Thus, in this manner, the wireless service provider provides a valuable service to their subscribers. Users are able to easily obtain printed versions of their digital photos in a convenient and seamless way. In addition, a wireless service provider may generate a new stream of income, there by benefiting from the transfer of photos across their network.

It is to be further appreciated that the present invention contemplates numerous additional options, variations, and alternatives. For example, because the wireless service provider may know the make and model of the particular phone used to take a picture, the wireless service provider may communicate such information or related information to the photofinishing service 22. Knowledge of such information may be used by the photofinishing service to assist in selecting optimum settings for the photofinishing process to thereby provide the user with as high of quality of photo prints as possible. Thus, subscribers to the wireless service provider may have an additional incentive to use the photofinishing service associated with the wireless service provider as opposed to any alternatives.

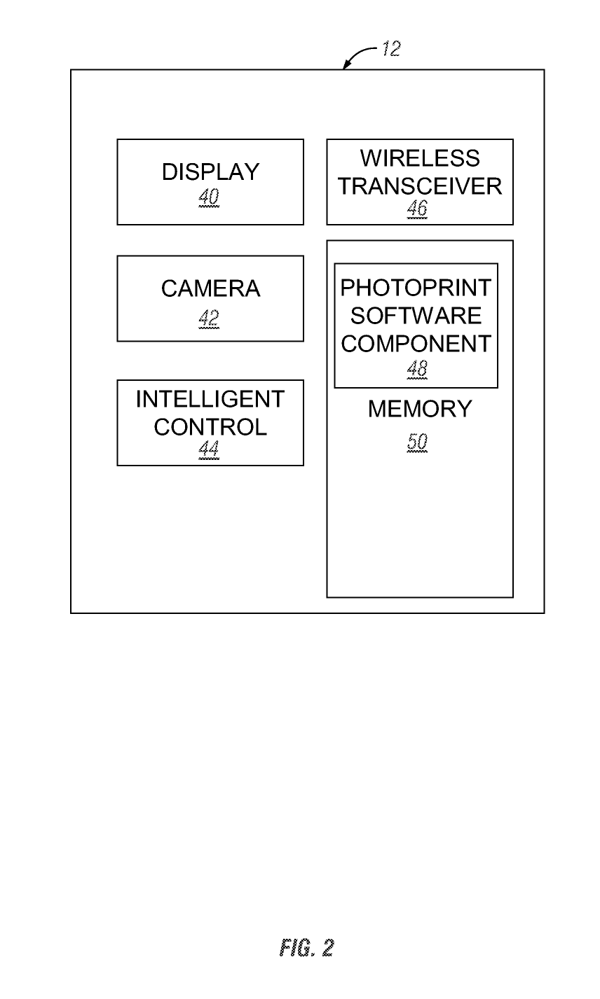

FIG. 2 is a block diagram illustrating one configuration of a wireless device 12 having a housing. The wireless device 12, which may be a cellular phone, includes a display 40, a camera 42, an intelligent control 44, a wireless transceiver 46, and a memory 50. A photo print software component 48 may be stored in the memory 50 and executed by the intelligent control 44. Alternatively a photo print component may be implemented in hardware. The intelligent control 44 may include an application processor or other type of processor. The photo print software component 48 may be a portion of photo or camera software associated with the wireless device 12. The photo print software component 48 may provide for displaying the icon or otherwise providing a user interface for a user to interact with to indicate whether a digital photo should be printed. The photo print software component 48 may be integrated into an operating environment or operating system of the wireless device 12. The photo print software component 48 may also provide for initiating transfer of one or more digital photos over a communication network so that the digital photos may be communicated to the photofinishing service. Although a representative device is shown in FIG. 2, it should be appreciated that the present invention contemplates numerous variations in the type of and form of the wireless device, its components, and functions.

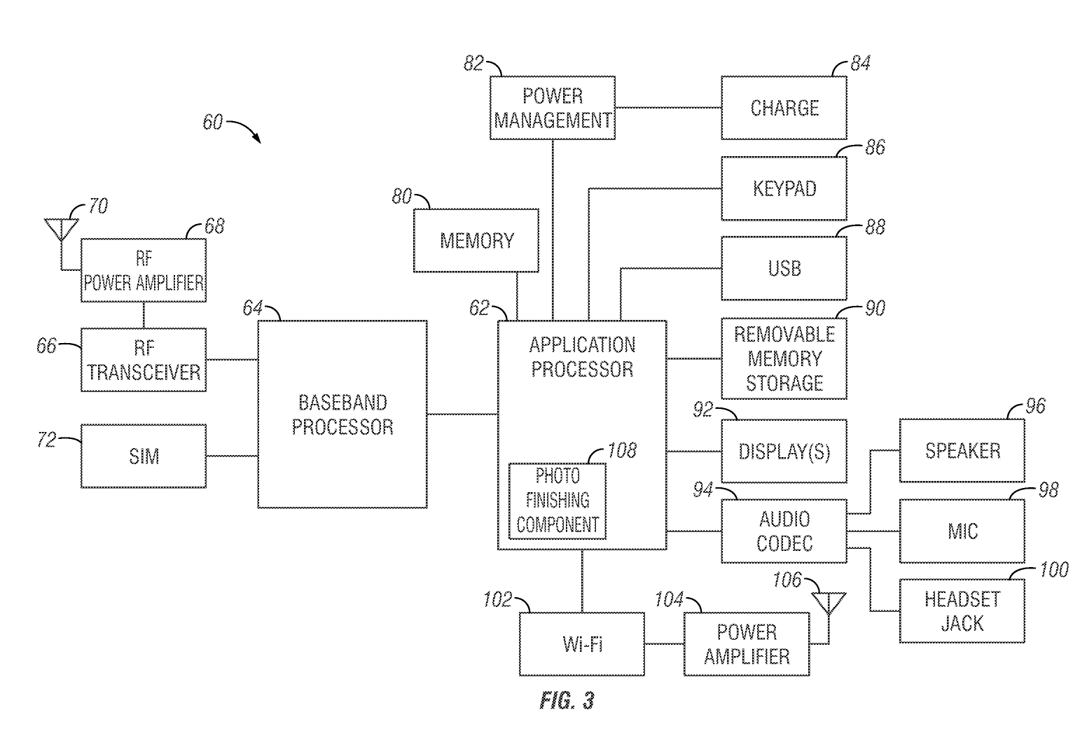

FIG. 3 illustrates another example of a block diagram of a representative device. FIG. 3 illustrates a wireless device 60. The wireless device 60 has an application processor 62 and a baseband processor 64 operatively connected to the application processor 62. An RF transceiver 66 is operatively connected to the baseband processor 64. An RF power amplifier 68 is operatively connected to the RF transceiver 66. An antenna 70 is operatively connected to the RF power amplifier 68. A SIM card 72 is shown which is operatively connected to the baseband processor 64. Although a SIM card is shown, other types of identifier modules may be used instead as would be appropriate for a particular type of network.

A memory 80 is operatively connected to the application processor 62. A power management circuit 82 is also operatively connected to the application processor 62 and to a charging circuit 84. A keypad 86, USB port 88, removable memory storage connection 90, and display(s) 92 are all operatively connected to the application processor 62. An audio codec 94 is operatively connected to the application processor 62. A speaker 96, microphone 98, and headset jack 100 are all operatively connected to the audio codec. A Wi-Fi transceiver 102 is operatively connected to the application processor 62. A power amplifier 104 is operatively connected to the Wi-Fi transceiver 102. An antenna 106 is operatively connected to the power amplifier 104.

As shown in FIG. 3, the application processor 62 includes an embedded photo-finishing component 108. The photo-finishing component 108 as shown includes a hardware component which may be implemented within the application processor 62 or may otherwise be included within an integrated circuit or “chip.”

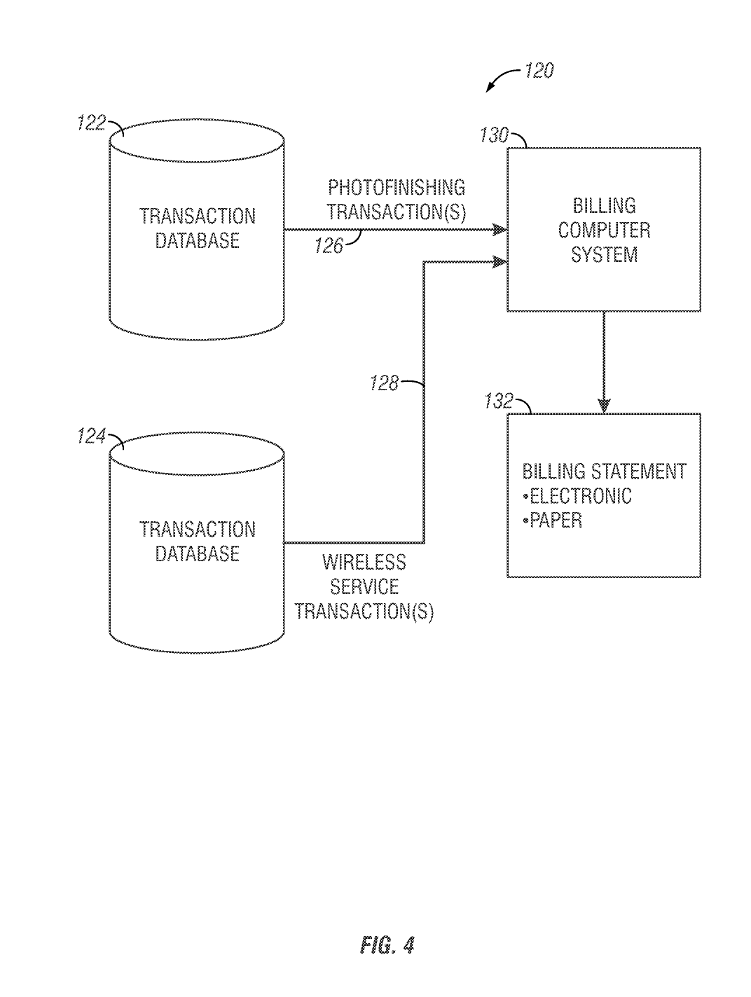

FIG. 4 is a block diagram illustrating one embodiment of a system 120 which may be used for billing. As shown in FIG. 4, there is a first transaction database 122 and a second transaction database 124. The first transaction database 122 contains data describing photo-finishing transactions 126. The photo-finishing transactions may include a periodic (e.g. monthly charge), a charge for an individual photoprint, a charge for a set of photoprints, and/or other charges associated with photo-prints. The second transaction database 124 contains data describing wireless service transactions 128. The transactions include charges for phone service, charges for text messaging, charges for data services, or other charges associated with the offering of wireless services. Although shown as two separate databases in FIG. 4, it is to be understood that instead of database 122, the photo-finishing transactions may be contained within transaction database 124. Or alternatively, wireless services transactions may be contained in the transaction database 122.

A billing computer system 130 is shown. The billing computer system 130 may include one or more computers operatively connected to the first transaction database 122 and the second transaction database 124. The billing computer system 130 collects at least one photo-finishing transaction 126 such as from the first transaction database 122 and at least one wireless service transaction 128 such as from the second transaction database 124. The billing computer system 130 then generates a billing statement or invoice which includes the at least one photo-finishing transaction and the at least one wireless service transaction. The billing statement may be an electronic billing statement or a paper billing statement or may take other forms.

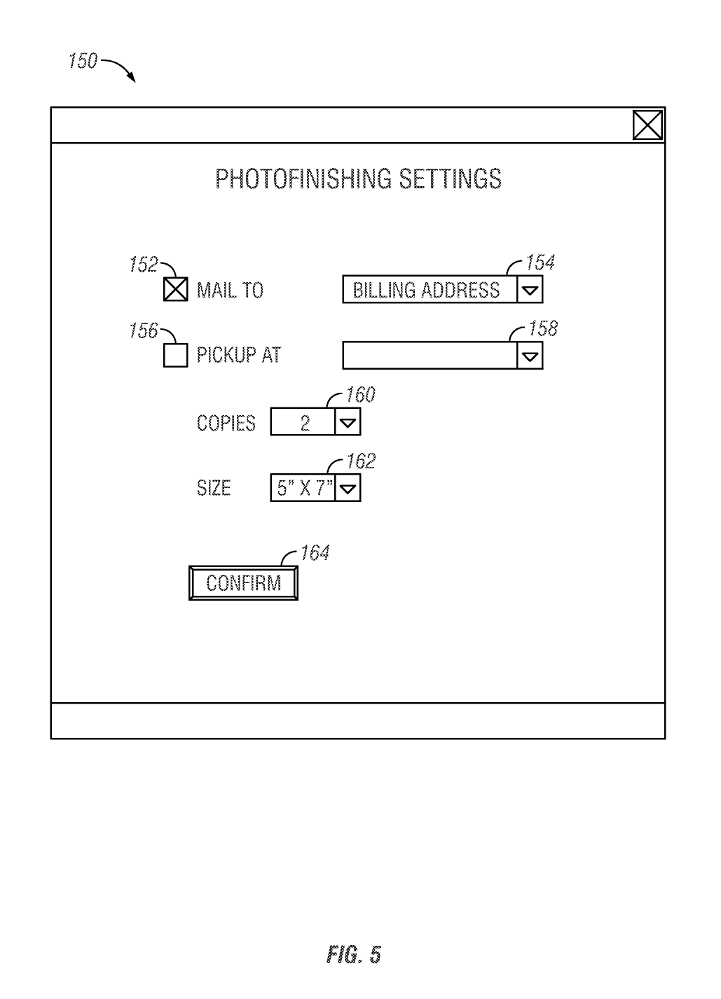

FIG. 5 illustrates one example of a screen display from a wireless device. The screen display 150 allows a user to set photofinishing settings. The user can, for example, select a mail option 152 which would allow for mailing photo prints to a physical address 154 of the user's choice. The physical address may be the billing address used for wireless service, it may be a home address of the user, a business address of the user, or any address the user would like the photo prints to be delivered to. In addition, or alternatively, the user can specify that the photo prints be picked up at a pickup location 158. The pickup location can be any location chosen by the user. The pickup location thus may be a photo shop, a drugstore, retail store or other location which provides photo finishing services. The pickup location may also be a retail store of a wireless service provider location.

The user can also specify the number of copies 160 and the size of the photo prints. It is to be further understood that the user may otherwise specify photo print parameters or delivery options. In addition, it is contemplated that the photo finish settings may be used as default setting so that a user of the wireless device only needs to access the photo finishing settings when the user wants to change the settings from their default settings.

What is claimed is:

1. A method comprising:
providing a wireless device to a user wherein the wireless device comprises (a) a housing, (b) a camera, (c) a wireless transceiver disposed within the housing, (d) an intelligent control operatively connected to the camera and the wireless transceiver, and (e) a photo print component wherein the photo print component assists in receiving an indication from a user that a digital photo acquired by the camera is to be printed and communicating the digital photo using the wireless transceiver over a cellular network;
storing within a database a transaction record associated with photo printing of the digital photo; and
electronically generating a bill containing the transaction record associated with photo printing of the digital photo and at least one transaction record associated with providing a telecommunications service over the wireless device.

2. The method of claim 1 wherein the photo print component includes elements integrated into the operating environment of the wireless device.

3. The method of claim 1 wherein the photo print component is at least partially implemented in hardware.

4. The method of claim 1 wherein the photo print component is at least partially implemented within an integrated circuit.

5. The method of claim 1 further comprising printing the bill.

6. The method of claim 1 wherein the bill is an electronic bill.

7. The method of claim 1 wherein the transaction record associated with photo printing of the digital photo is for purchase and delivery of at least one photo print.

8. The method of claim 1 wherein the transaction record associated with photo printing of the digital photo is for purchase and pickup of at least one photo print.

9. The method of claim 1 wherein the transaction record associated with photo printing of the digital photo is a periodic charge for a set number of photo prints.

10. The method of claim 1 wherein the transaction record associated with photo printing of the digital photo is a periodic charge for an unlimited number of photo prints.

11. The method of claim 1 further comprising printing the digital photo.

12. The method of claim 11 further comprising setting parameters for printing the digital photo based on the wireless device used to acquire the digital photo.

13. The method of claim 1 wherein the wireless device is a cellular phone.

14. The method of claim 1 wherein the photo print component assists in displaying on a display of the wireless device an icon associated with photo print services.

15. A method, comprising:
receiving a digital photograph from a wireless device associated with a subscriber to a wireless service over a telecommunication network;
printing at least one print of the digital photograph;
transferring the at least one print of the digital photograph to the subscriber of the wireless service;
billing the subscriber of the wireless service for the at least one print of the digital photograph on a bill which also bills the subscriber of the wireless service for use of the wireless service.

16. The method of claim 15 wherein the transferring comprises mailing the at least one print of the digital photograph to the subscriber of the wireless service.

17. The method of claim 15 wherein the billing comprises billing for the at least one print of the digital photograph on a per print basis.

18. The method of claim 15 further comprising queuing a set of digital photographs including the digital photograph and printing and transferring the digital photograph as a part of the set of digital photographs.

19. A method for providing wireless services, comprising:
collecting a first transaction record from a database for a wireless service;
collecting a second transaction record for a photo printing service; and
electronically generating a bill containing the first transaction record and the second transaction record using a computerized billing system.

20. The method of claim 19 further comprising providing a wireless device to a user wherein the wireless device comprises (a) a housing, (b) a camera, (c) a wireless transceiver disposed within the housing, (d) an intelligent control operatively connected to the camera and the wireless transceiver, and (e) a photo print component wherein the photo print component assists in receiving an indication from a user that a digital photo is to be printed.

21. The method of claim 20 further comprising receiving the indication from the user that a digital photo is to be printed.

22. The method of claim 21 further comprising printing the digital photo.

23. A cellular phone, the cellular phone comprising:
a housing:
a camera;
a wireless transceiver disposed within the housing;
an intelligent control; and
a photo print component integrated into an operating environment of the cellular phone, wherein the photo print component provides for receiving an indication from a user that a digital photo acquired by the cellular phone is to be printed and then communicating the digital photo using the wireless transceiver over a cellular network.

24. The cellular phone of claim 23 wherein the indication from the user is selection of an icon.

25. The cellular phone of claim 23 wherein the communicating the digital photo using the wireless transceiver over the cellular network comprises communicating the digital photo to a wireless service provider associated with a photofinishing service.

26. A method, comprising:
providing wireless service to a wireless device associated with a wireless service subscriber;
providing the wireless device to the wireless service subscriber;
providing on the wireless device means to select a digital photograph for photo printing to a photo printing service associated with a provider of the wireless service; and
electronically generating a bill containing a first transaction record associated with the photo printing service and a second transaction record associated with the wireless service using a computerized billing system.

27. The method of claim 26 wherein the wireless device is a cellular phone.
